(19) United States
(12) Patent Application Publication
(10) Pub. No.: US 2005/0242107 A1
(43) Pub. Date: Nov. 3, 2005

(54) Part dispenser assembly

(76) Inventors: Michael J. Kosmyna, Toledo, OH (US); Ralph A. Wisniewski, Toledo, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 10/834,523

(22) Filed: Apr. 29, 2004

(51) Int. Cl. B65H 3/28; B67D 5/378; B67D 5/33; B67D 5/32; B67B 5/00; B65G 59/00; G07F 11/00; B65H 3/44; G07F 11/16

(52) U.S. Cl. 221/223; 221/124

(57) ABSTRACT

A part dispenser assembly for use with a carton containing parts, the carton having sides, a top, and an open bottom, the parts having an opening therein. The part dispenser assembly includes a part dispensing container having sides, an open top, and a bottom having an opening therein for dispensing parts, the part dispensing container adapted to receive the carton containing parts; a member retainer; a flexible part retainer; and a member adapted to be threaded through the opening in the parts, the top of the member adapted to be attached to the member retainer and the bottom of the member adapted to be attached to the flexible part retainer, wherein the flexible part retainer is adapted to retain the parts in the part dispensing container and wherein the parts are dispensed by deforming the flexible part retainer so that it passes through the opening in the parts. The invention also involves a method of dispensing parts.

### BACKGROUND OF THE INVENTION

The invention relates generally to a dispenser for parts, and more particularly to a part dispenser assembly which can be used in conjunction with the carton containing parts.

It can be difficult to dispense disposable cups and lids quickly and conveniently. The cups and lids often stick together, making dispensing individual cups or lids difficult. Frequently, different sizes of cups and lids must be dispensed, which adds to the problem. Even when the cups and lids are not used for foods to be consumed, cleanliness may be important, such as for disposable paint cups and lids.

Lids pose a particularly difficult challenge. Lids are often dispensed from open bins, or free standing stacks. Neither of these provides a good solution. The lids can stick together, requiring two hands to separate a single lid from the stack. Lids may fall to the floor and become contaminated so they cannot be used. Lid dispensing devices have been developed, but these are often complicated, expensive to manufacture, and hard to use. Moreover, the top of a wall-mounted unit may be six feet high, making refilling the devices difficult.

When the lids have a raised opening in the center, as with some disposable lids for paint cups, the lids do not nest or stack. If the lids are stored in a closed bin with a door, more than one lid may be dispensed at a time.

Therefore, there is a need for a part dispenser which is easy to manufacture and use.

### SUMMARY OF THE INVENTION

The present invention meets this need by providing a part dispenser assembly. The part dispenser assembly includes a part dispensing container having sides, an open top, and a bottom having an opening therein for dispensing parts; a carton containing parts, the carton having sides, a top, and an open bottom, the parts having an opening therein, the open bottom of the carton containing parts positioned in the part dispensing container; a member retainer; a flexible part retainer; and a member threaded through the opening in the parts, the top of the member attached to the member retainer and the bottom of the member attached to the flexible part retainer, wherein the flexible part retainer retains the parts in the part dispensing container and wherein the parts are dispensed by deforming the flexible part retainer so that it passes through the opening in the parts.

Another aspect of the invention is a part dispenser assembly for use with a carton containing parts, the carton having sides, a top, and an open bottom, the parts having an opening therein. The part dispenser assembly includes a part dispensing container having sides, an open top, and a bottom having an opening therein for dispensing parts, the part dispensing container adapted to receive the carton containing parts; a member retainer; a flexible part retainer; and a member adapted to be threaded through the opening in the parts, the top of the member adapted to be attached to the member retainer and the bottom of the member adapted to be attached to the flexible part retainer, wherein the flexible part retainer is adapted to retain the parts in the part dispensing container and wherein the parts are dispensed by deforming the flexible part retainer so that it passes through the opening in the parts.

Another aspect of the invention is a method of dispensing parts. The method includes providing a part dispensing container having sides, an open top, and a bottom having an opening therein for dispensing parts; providing a carton containing parts, the carton having sides, a top, and a bottom, the parts having an opening therein; opening the bottom of the carton containing parts; threading a member having a flexible part retainer thereon through the opening in the parts, the flexible part retainer positioned at the bottom of the carton containing parts; attaching the member to a member retainer; positioning the bottom of the carton containing parts in the part dispensing container; deforming the flexible part retainer so that it passes through the opening in the part; and removing the part.

### BRIEF DESCRIPTION OF THE DRAWINGS

FIG. 1 is a cross section of the front of one embodiment of the part dispenser assembly of the present invention.

FIG. 2 is a cross section of the side of one embodiment of the part dispenser assembly of the present invention.

FIG. 3 is a cross section of the front of one embodiment of the part dispensing container of the present invention.

FIG. 4 is a cross section of a lid with the flexible part retainer.

FIG. 5 is a cross section of the front of another embodiment of the part dispenser assembly of the present invention.

### DETAILED DESCRIPTION OF THE INVENTION

Although the present invention will be described with reference to use with disposable paint cups and lids, one of ordinary skill in the art will appreciate that it can be used with other types of cups and lids. One of ordinary skill in the art will also appreciate that it can be used with any part having an opening in it through which a member can be threaded, as described below. For example, the part dispenser assembly could also be used to dispense funnels, such as paint funnels.

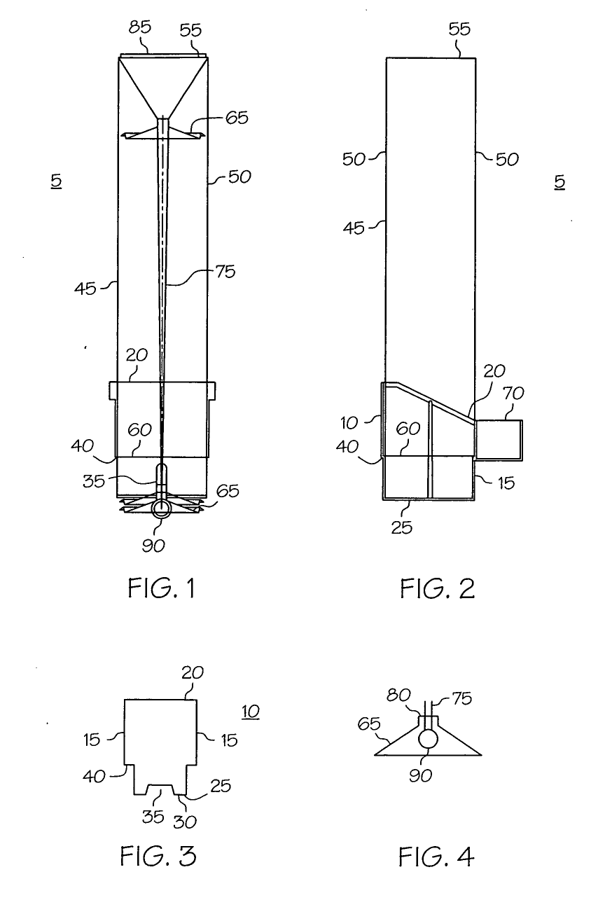

FIGS. 1-3 show the front and side of one embodiment of the part dispenser assembly 5 of the present invention. The part dispensing container 10 has four sides 15, an open top 20, and bottom 25. The bottom 25 has an opening 30 in it, which allows the parts to be removed. The opening 30 in the bottom 25 can cover the entire bottom, or enough of the bottom to allow the parts to be removed. There can optionally be an opening 35 in the front of the part dispensing container 10 for easy access to the parts.

A carton 45 having sides 50, top 55, and bottom 60 is placed in the part dispensing container. Before the carton 45 is placed in the part dispensing container 10, the bottom of the carton is removed. When the carton 45 is placed in the part dispensing container 10, the bottom 60 of the carton 45 can be supported by the optional ledge 40. The ledge can be formed by reducing the size of the inside of the part dispensing container 10, as shown, or by incorporating a ledge on the inside. The ledge should be sized so that it does not interfere with the movement of the parts towards the bottom. The open bottom 60 of the carton allow the lids 65 to slide down to the bottom 25 of the part dispensing container 10.

The part dispensing container 10 can optionally include a bin 70 for storage of small parts, such as filters and plugs which may be used with the paint cups.

There is a member 75 threaded through the openings 80 in the lids 65 in the carton 45. The member 75 can be made of a flexible material, such as a string, or a rigid material, such as rod or dowel. If a string is used, it can be a continuous loop, or it can be tied to form a loop. Alternatively, it can be a single length, with loops formed on one or both ends, for example.

At the top, the member 75 is held by a member retainer 85. The member retainer 85 prevents the member 75 from sliding down through the openings 80 in the lids 65. The member retainer 85 can be the top 55 of the carton 45. In this arrangement, a loop of string can be placed around the top 55 of the carton 45, for example. Alternatively, the member retainer 85 could be a hook, which could be attached to the part dispensing container or to a wall, if desired. The string could be tied to the member retainer 85, if desired. The stack of lids is suspended by the member 75 from the member retainer 85.

The member 75 is attached to a flexible part retainer 90 at the bottom. The flexible part retainer 90 is bigger than the opening 80 in the lid 65. Therefore, the lids 65 will not fall off the member 75. The flexible part retainer 90 can be easily deformed so that it will fit through the opening 80 in the lid 65, allowing the lid to be removed. The flexible part retainer 90 will return to its original shape after it passes through the opening 80 in the lid 65, and prevent another lid from being dispensed. The flexible part retainer 90 can be any shape which will retain the lids in the part dispensing container 10. Suitable flexible part retainers include, but are not limited to, O-rings, which are readily available and inexpensive.

The member can be threaded through the openings in the parts before the parts are sealed in the carton. In this arrangement, the carton of parts would be ready for use when it is opened. Alternatively, the customer can thread the member through the parts after the carton is opened. If a string is used, the customer could use a long hook or the like to thread the string through the openings. The member 75 can be recycled, reused, or thrown away, as desired. If the member is threaded through the openings before the parts are sealed in the carton, the member will likely be thrown away because the new carton will be ready for use. Rigid members are more likely to be recycled or reused than flexible members.

The part dispenser assembly can include more than one part dispensing container, each with its own carton of parts, if desired.

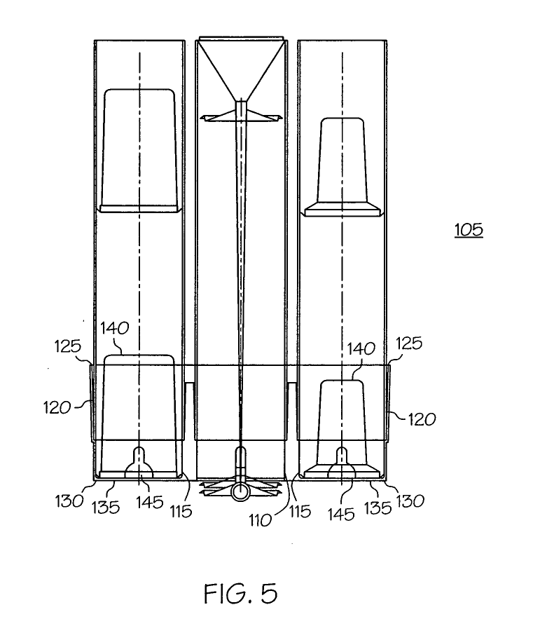

The part dispenser assembly can optionally include cup dispensing assemblies as shown in FIG. 5. The part dispenser assembly 105 includes a lid dispensing container 110 and two cup dispensing containers 115. There could be one or more lid dispensing containers and one or more cup dispensing containers, as needed.

The cup dispensing containers 115 have sides 120, top 125, and bottom 130. The bottom 130 has an opening 135 in it to allow the cups 140 to be removed from the cup dispensing containers 115. The opening 135 is typically smaller than the bottom 130 so that the cups remain in the cup dispensing container until they are removed. There can optionally be an opening 145 in the front of the cup dispensing container 115 to allow the cups to be removed more easily.

The part dispenser assembly of the present invention allows easy filling and will dispense only one part at a time. The part dispenser container can be mounted on the wall, if desired. When the dispenser is empty, the empty carton of parts can be removed from the dispenser and thrown away. The bottom of a new carton of parts can be removed. The member can be threaded through the openings in the part. The part retainer can be on the member when it is threaded through, or it can be attached afterwards. The carton can be placed in the part dispensing container. The member can be attached to the member retainer before or after the carton is placed in the part dispensing container, depending on what type of member retainer is used. The parts can be dispensed by deforming the flexible part retainer so that it passes through the opening in the part. The flexible part retainer will return to its original shape when it is through the opening in the part so that no other parts are dispensed.

While certain representative embodiments and details have been shown for purposes of illustrating the invention, it will be apparent to those skilled in the art that various changes in the apparatus and methods disclosed herein may be made without departing from the scope of the invention, which is defined in the appended claims.

1. A part dispenser assembly comprising:
a part dispensing container having sides, an open top, and a bottom having an opening therein for dispensing parts;
a carton containing parts, the carton having sides, a top, and an open bottom, the parts having an opening therein, the open bottom of the carton containing parts positioned in the part dispensing container;
a member retainer;
a flexible part retainer; and
a member threaded through the opening in the parts, the top of the member attached to the member retainer and the bottom of the member attached to the flexible part retainer, wherein the flexible part retainer retains the parts in the part dispensing container and wherein the parts are dispensed by deforming the flexible part retainer so that it passes through the opening in the parts.

2. The part dispenser assembly of claim 1 wherein the member retainer is a hook.

3. The part dispenser assembly of claim 1 wherein the member retainer is attached to the part dispensing container.

4. The part dispenser assembly of claim 1 wherein the member retainer is the top of the carton containing parts.

5. The part dispenser assembly of claim 1 wherein the flexible part retainer is an O-ring.

6. The part dispenser assembly of claim 1 further comprising a bin attached to the part dispensing container.

7. The part dispenser assembly of claim 1 wherein the part dispensing container has a ledge on the inside to support the carton containing parts.

8. The part dispenser assembly of claim 1 wherein the side of the part dispensing container has an opening.

9. The part dispenser assembly of claim 1 wherein there are at least two part dispensing containers.

10. The part dispenser assembly of claim 1 wherein the parts are selected from lids or funnels.

11. The part dispenser assembly of claim 1 further comprising a cup dispenser assembly comprising:
a cup dispensing container attached to the part dispensing container, the cup dispensing container having sides, an open top, and a bottom having an opening therein for dispensing cups; and
a carton containing cups, the carton having sides, a top, and an open bottom, the open bottom of the carton containing cups positioned in the cup dispensing container.

12. The part dispenser assembly of claim 11 wherein there are at least two cup dispensing containers.

13. The part dispenser assembly of claim 11 wherein the cup dispensing container has a ledge on the inside to support the carton containing cups.

14. The part dispenser assembly of claim 11 wherein the side of the cup dispensing container has an opening.

15. A part dispenser assembly for use with a carton containing parts, the carton having sides, a top, and an open bottom, the parts having an opening therein, the part dispenser assembly comprising:
a part dispensing container having sides, an open top, and a bottom having an opening therein for dispensing parts, the part dispensing container adapted to receive the carton containing parts;
a member retainer;
a flexible part retainer;
a member adapted to be threaded through the opening in the parts, the top of the member adapted to be attached to the member retainer and the bottom of the member adapted to be attached to the flexible part retainer, wherein the flexible part retainer is adapted to retain the parts in the part dispensing container and wherein the parts are dispensed by deforming the flexible part retainer so that it passes through the opening in the parts.

16. The part dispenser assembly of claim 15 further comprising a cup dispenser assembly for use with a carton containing cups, the carton having sides, a top, and an open bottom, the cup dispenser assembly comprising:
a cup dispensing container attached to the part dispensing container, the cup dispensing container having sides, an open top, and a bottom having an opening therein for dispensing cups, the cup dispensing container adapted to receive the carton containing cups.

17. The part dispenser assembly of claim 15 further comprising a bin attached to the part dispensing container.

18. The part dispenser assembly of claim 15 wherein the part dispensing container has a ledge on the inside to support the carton containing parts.

19. The part dispenser assembly of claim 15 wherein the flexible part retainer is an O-ring.

20. The part dispenser assembly of claim 15 wherein the parts are selected from lids or funnels.

21. A method of dispensing parts comprising:
providing a part dispensing container having sides, an open top, and a bottom having an opening therein for dispensing parts;
providing a carton containing parts, the carton having sides, a top, and a bottom, the parts having an opening therein;
opening the bottom of the carton containing parts;
threading a member having a flexible part retainer thereon through the opening in the parts, the flexible part retainer positioned at the bottom of the carton containing parts;
attaching the member to a member retainer;
positioning the bottom of the carton containing parts in the part dispensing container;
deforming the flexible part retainer so that it passes through the opening in the part; and
removing the part.
